(19) United States
(12) Patent Application Publication
(10) Pub. No.: US 2006/0266912 A1
(43) Pub. Date: Nov. 30, 2006

(54) Apparatus for holding a catheter bag

(76) Inventor: John McGuire, Ayrshire (GB)

Correspondence Address: DYKAS, SHAVER & NIPPER, LLP, P.O. BOX 877, BOISE, ID, 83701-0877, US

(21) Appl. No.: 10/516,486

(22) PCT Filed: May 2, 2003
(86) PCT No.: PCT/GB03/01923

§ 371 Date: May 18, 2005

(30) Foreign Application Priority Data
May 31, 2002 (GB) 0212597.9

(51) Int. Cl. F16M 13/00

(52) U.S. Cl. 248/542

(57) ABSTRACT

Apparatus for holding a medical bag, such a catheter or drip bag, is generally depicted at (1), and comprises a first lower component (2), second upper component (5), indicator means (12) and attachment means for the medical bag (8). The upper component is adapted to move relative to the lower component as the contents of the catheter or drip bag increase or decrease, and this activates the indicator means which acts as a warning that the contents of the bag require emptying or changing.

The present invention relates to medical apparatus. More particularly the present invention relates to apparatus for holding a catheter or drip bag, which can be used to detect when the contents of the bag reach a certain level, and to report when the bag requires emptying or filling.

A catheter is a thin and flexible tube inserted into a bodily passage or cavity in order to allow fluids to pass into or out of it. The catheter is generally connected to a catheter bag, which collects the fluids passing out, or a drip bag which stores the fluids passing into the body. Catheterisation is commonly used in hospitals, care homes and medical centres for seriously ill patients, or those who are confined to a bed or wheelchair.

As catheter or drip bags have a finite capacity (usually around 2000 ml) nursing and/or care staff must check the bags on a regular basis, to empty them if full or to fill them if empty.

Where the catheter is being used for excretion collection, i.e. for the passage of fluids out of the body, overfilling of the catheter bag can cause a backflow through the tubing and back into the body, and particularly into the bladder and kidney. This can result in infection of the urinary tract of the patient, which may necessitate a further treatment. As the patient will need to remain in the hospital for longer than would otherwise be necessary, the cost of caring for the patient is greatly increased and valuable resources are wasted on treating what is, essentially an avoidable situation.

However in busy hospitals or care homes, it may be difficult for the nursing staff to check the catheter or drip bags as often as would be desirable. The need to visit every patient's bed to check the contents of the bag on a regular basis uses up valuable staffing time. A further problem lies in the fact that, at present, catheter bags are often stored under the bed of the patient. This adds to the inconvenience to nursing staff who must actively go around every bed and pull out the bag to check its contents.

It is therefore an object of the present invention to provide an apparatus, which can be used to hold a catheter or drip bag in a position where the contents can be easily viewed. An associated object of the present invention is to provide an apparatus, which can be used to detect when the contents of the catheter or drip bag reach a certain level and which provides an indication or warning when the bag requires emptying or filling.

According to a first aspect of the present invention, there is provided apparatus capable of indicating when the contents of a medical bag reach a certain level, the apparatus comprising indicator means, and a first and second component, wherein the first component has attachment means for holding the medical bag and is adapted to move relative to the second component as the contents of the medical bag change, wherein movement of the first component activates the indicator means.

Typically the medical bag is of the type commonly known as a catheter bag or a drip bag.

Preferably the first and second components are hollow tubulars.

Preferably, as the contents of the medical bag fill, in the case of a catheter bag, or empty, in the case of a drip bag, the first component moves in a substantially vertical direction relative to the second component.

The first and second components may be manufactured from a metal or plastics material. Preferably, the hollow tubulars are manufactured from stainless steel.

Preferably the first and second components are arranged such that the first component is positioned above and engages with the second component.

In a preferred embodiment the lowermost region of the first component is positioned substantially within the uppermost region of the second component. In order to facilitate this the diameter of at least the lowermost region of the first component may be smaller than the diameter of at least the uppermost region of the second component.

In an alternative embodiment the lowermost region of the first component is positioned substantially over the uppermost region of the second component. In order to facilitate this the diameter of at least the lowermost region of the first component may be larger than the diameter of at least the uppermost region of the second component.

Preferably a compression spring is located within the second component.

Preferably one of either the first or second component contains a magnetic array. Typically, the other of the first or second component contains a magnetic detector or sensor.

Preferably the magnetic detector or sensor is a read switch.

Preferably the first component makes contact with the compression spring. Typically the first component sits on the compression spring.

Preferably the compression spring is calibrated.

Preferably the indicator means is activated when the magnetic detector or sensor comes into proximity with the magnetic array.

The indicator means may comprise one or more indicator lights or an audible signal.

In one embodiment the magnetic detector or sensor and magnetic array are brought into proximity with each other as the bag fills. As it fills, the weight of the bag moves the first component in a substantially downward direction on the compression spring located in the second component. This causes the magnetic detector or sensor to come into proximity with the magnetic array.

In an alternative embodiment the magnetic detector or sensor and magnetic array are brought into proximity with each other as the bag empties. As it empties, the reduction in weight of the bag moves the first component in a substantially upward direction on the compression spring located in the second component. This causes the magnetic detector or sensor to come into proximity with the magnetic array.

The indicator means may be battery powered.

Optionally the indicator means is located on one or both of the upper or lower components. In an alternative embodiment the indicator means is located in a remote location to the apparatus.

The apparatus may also comprise a third component. The indicator means may be located on the third tubular component. Where the indicator means is battery operated, battery access may be positioned in the third tubular component.

Preferably the apparatus is free standing. To facilitate standing, the lower component may have a base. The base may have a plurality of feet.

An example embodiment of the present invention is described with reference to the following Figures, in which:

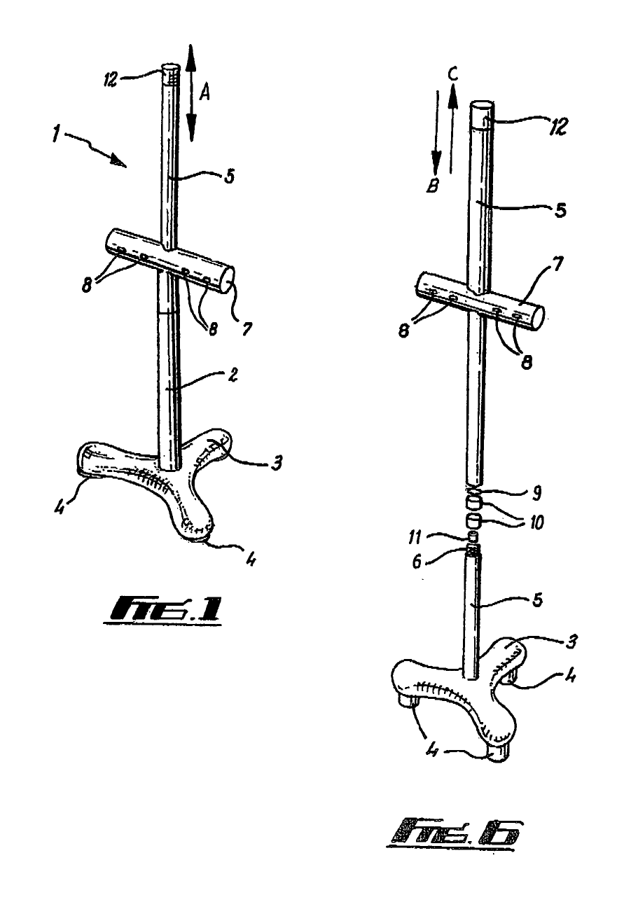

FIG. 1 is a pictorial view of the apparatus of the present invention;

FIG. 2 is an engineering drawing of the apparatus from the side;

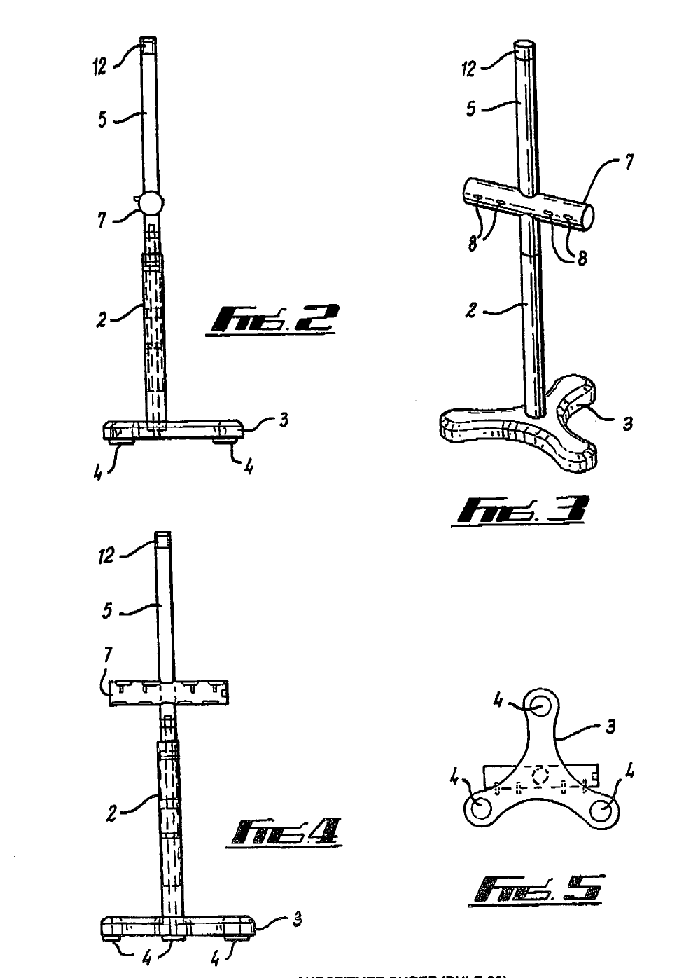

FIG. 3 is an engineering drawing of the apparatus viewed at an angle;

FIG. 4 is an engineering drawing of the apparatus from the back;

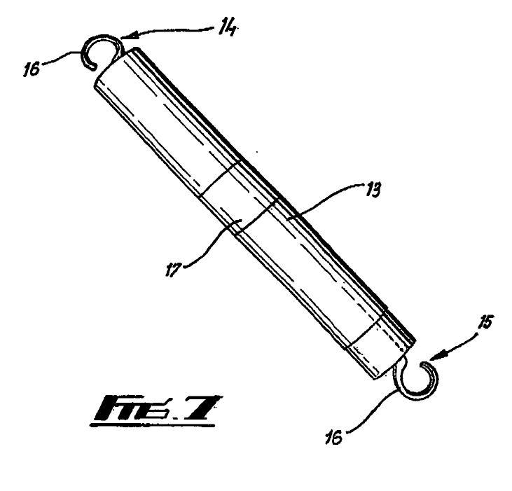

FIG. 5 is an engineering drawing of the apparatus from below;

FIG. 6 is an exploded view of the apparatus, and

FIG. 7 illustrates the tubular used in connection with a drip bag.

Referring firstly to FIG. 1, the apparatus for holding a medical bag such as a catheter or drip bag is generally depicted at 1. The apparatus comprises a first lower component 2, which in the depicted embodiment is comprised of a hollow tubular, mounted on a base 3. The base 3, supports the apparatus and may also have feet 4 to improve grip. The feet may be manufactured from a rubber material. A second upper component 5 is also comprised of a hollow tubular. In the depicted embodiment the lowermost part of the upper component is inserted or positioned in at least the uppermost part of the lower component 2. At least the lower portion of the upper component is generally smaller in diameter than at least the upper portion of the lower component and as a result the upper component can move relative to the lower component in the direction indicated by arrow A. Both parts 2 and 5 are manufactured from stainless steel, which has advantageous hygienic properties. However it is recognised that the apparatus may also be manufactured from other metal materials or plastic. The upper and lower component smay be welded or secured by other means which further aids hygiene. The base 3, may be manufactured from aluminium. The components and base may also be coated by a sterile coating to increase hygiene and to allow the apparatus to be moved from ward to ward without the risk of cross infection. The base of the apparatus may optionally have wheels to permit easy movement.

FIGS. 2 to 5 show the apparatus from a number of different angles.

The upper component can move in a vertical direction relative to the lower component, as illustrated by arrow A, due to the inclusion of a compression spring 6 which in the depicted embodiment is located within the lower component. The upper component sits on the compression spring. A magnetic array 11 is also contained within the apparatus. In the depicted embodiment (FIG. 6) the magnetic array is located within the lower component, although it in an alternative embodiment the magnetic array may be located within the upper component. In the depicted embodiment the magnetic array is provided as a circular magnet cluster. Also located within the tubulars and associated with the compression spring are stop ring 9, and bushes 10. The apparatus will have 360° rotational movement.

The apparatus also contains a magnetic sensor or detector 18 which may take the form of one or more read switches (otherwise known as reed switches). Where the magnetic array is located within the lower component the magnetic sensor or detector will be located in the upper component and vice versa.

The upper 5 component has a t-bar 7, on which are located one or more attachment means 8. A standard catheter or drip bag, of the type commonly used in hospitals or care homes can be mounted on the apparatus using the attachment means S. The attachment means 8 may take the form of pegs, clips or hooks.

In the depicted embodiment, indicator means 12 is activated when the magnetic sensor or detector 18, which in the depicted embodiment is located in the upper component, comes into the proximity of the magnetic array 11, in the lower component. As the weight of the catheter bag increases as it fills the upper component is moved in a downward direction on the compression spring. This causes the magnetic sensor or detector in the upper component to move towards the magnetic array in the lower component. In other words as the catheter bag fills, and the volume of the contents of the catheter bag increases, the increased weight of the bag will pull upper component 5 in a downward direction towards lower component 2 on compression spring 6, in the direction of arrow S. It will be appreciated that the positioning of the magnetic array and magnetic sensor or detector could equally be reversed, such that the magnetic array is located in the upper component and the magnetic sensor or detector is located in the lower component.

When the magnetic array come into close proximity with the magnetic detector or sensor the indicator means is activated, which notifies nursing or care staff that the contents of the bag have reached a particular level and require emptying. The position of the read switch and magnetic array within the components is such that this will occur when contents of the bag reach a predetermined quantity. Activation will typically occur through the generation of an electric current, and the hollow tubulars are adapted to receive one or more batteries. The batteries may be standard or rechargeable. In an example embodiment, using standard sized catheter bags (2000 ml), activation when the contents of the bag reach 1800 ml. As many catheter bags can hold 2000 ml of fluid, activation of the indication means when the contents of the bag reach 1800 ml gives the nursing or care staff time to empty the bag before it becomes entirely full and backflows into the associated tubing. However it should be recognised that the calibration of the spring can be changed, and that the apparatus is not limited to work at these volumes. The apparatus may be adapted to activate the indication means when the capacity of the bag is less or more than 1800 ml depending on the situation.

In an alternative embodiment, where fluid (such as plasma or saline) is being passed into the body, the weight of the bag will gradually decrease as the medical bag empties and the volume of the contents of the bag decreases. In this embodiment the upper component 5 will move in the direction of arrow C, as less weight is exerted on compression spring 6. The magnetic array and magnetic detector or sensor will be positioned within the first and second components such that as the upper component moves in direction C, they are brought into proximity with each other. When the magnetic array comes into close proximity with the magnetic detector or sensor the indicator means is activated, to notify nursing or care staff that the contents of the bag are low and it requires filling.

It is also recognised that alternative embodiments of the apparatus may be provided where activation of the indicator means is effected by a method other than the method which uses magnets and sensors depicted in the Figures. For example in an alternative embodiment the magnetic array and detector may be replaced by a simple mechanical switch which is moved from an off to an on position when the upper component moves to a predetermined position relative to the lower component. The switch may be located in either of the upper or lower components and is moved to the on position when the upper component reaches a certain predetermined position relative to the lower component.

In the depicted embodiment, the indication means comprises one or more warning lights 12 provided as one or more LED lens. The warning lights are located on the entire circumference of the tubular component to provide 360° visibility. Three warning lights of red, amber and green, are provided in the depicted embodiment. These will provide an escalating level of warning relating to the contents of the bag. For example, using the Figures given above, at 1600 ml the green light may be activated. At 1700 ml the amber light may be activated and at 1800 ml the red light may be activated. The volume at which the indicator is avtivated may be altered as desired. This will give nursing staff an advance indication of how full the catheter bag is. Alternatively, the indication means may be flashing light. The indicating means may also comprise a buzzer or some other audible signal. It will be appreciated that the use of lights or buzzers are particularly beneficial for use at night. The indicator will de-activate once the bag is drained or replaced.

The apparatus may also comprise a third tubular component as shown in FIG. 7. The third tubular component 13 will typically have a first end 14 which can be attached to the stand, and a second end 15 to which the catheter or drip bag can be attached. The first end may be attached to the attachment means 8 on the t-bar 7. The tubular is hollow and can hold one or more batteries (not shown). In this embodiment a tension spring is located within the hollow tubular and an indicator means typically being a LED lens 17 is provided on the tubular body. The first and second ends typically carry hooks 16, clamps or the like which facilitate attachment to the catheter or drip bag and stand. The indicator means will be activated when the contents of the bag reach a certain level and the weight the third component exerts on the upper component sufficiently increases or decreases to activate the indicator in the manner described above.

An indicator means may also be located in a remote location, for example at a nursing station, so that nursing and care staff can monitor all patients within a ward without having to undertake a ward round. This will greatly reduce the time spent by nursing staff monitoring patients, as they will not need to attned individual beds to check whether individual bags require emptying.

Further modifications and improvements may be incorporated without departing from the scope of the invention herein intended.

1. Apparatus capable of indicating when the contents of a medical bag reach a certain level, the apparatus comprising indicator means and a first and second component, wherein the first component has attachment means for holding the medical bag and is adapted to move relative to the second component as the contents of the medical bag change, wherein movement of the first component activates the indicator means.

2. Apparatus as claimed in claim 1, wherein the medical bag is a catheter bag or drip bag.

3. Apparatus as claimed in any one of the preceding claims, wherein the first and second components are hollow tubulars.

4. Apparatus as claimed in any one of the preceding claims, wherein as the volume of the contents of the medical bag changes, the first component moves in a substantially vertical direction relative to the second component.

5. Apparatus as claimed in any one of the preceding claims, manufactured from metal.

6. Apparatus as claimed in any one of claims 1 to 4, manufactured from a plastic material.

7. Apparatus as claimed in any one of claims 1 to 5, manufactured from stainless steel.

8. Apparatus as claimed in any one of the preceding claims, wherein the first and second components are arranged such that the first component is positioned above and engages with the second component.

9. Apparatus as claimed in any one of the preceding claims, wherein the lowermost region of the first component is positioned substantially within the uppermost region of the second component.

10. Apparatus as claimed in any one of the preceding claims, wherein the diameter of at least the lowermost region of the first component is smaller than the diameter of at least the uppermost region of the second component.

11. Apparatus as claimed in any one of claims 1 to 8, wherein the lowermost region of the first component is positioned substantially over the uppermost region of the second component.

12. Apparatus as claimed in claim 11, wherein the diameter of at least the lowermost region of the first component is larger than the diameter of at least the uppermost region of the second component.

13. Apparatus as claimed in any one of the preceding claims, wherein a compression spring is located within the second component.

14. Apparatus as claimed in claim 13, wherein the first component makes contact with the compression spring.

15. Apparatus as claimed in claims 13 to 14, wherein the first component sits on the compression spring.

16. Apparatus as claimed in claims 13 to 15, wherein the compression spring is calibrated.

17. Apparatus as claimed in any one of the preceding claims, wherein one of either the first or second component contains a magnetic array.

18. Apparatus as claimed in claim 17, wherein the other of the first or second component contains a magnetic detector or sensor.

19. Appartus as claimed in claim 18, wherein the magnetic detector or sensor is a read switch.

20. Apparatus as claimed in any one of the preceding claims, wherein the indicator means is activated when the magnetic detector or sensor comes into proximity with the magnetic array.

21. Apparatus as claimed in any one of the preceding claims, wherein the indicator means comprises one or more indicator lights.

22. Apparatus as claimed in any one of the preceding claims, wherein the indicator means comprises an audible signal.

23. Apparatus as claimed in any one of the preceding claims, wherein the magnetic detector or sensor and magnetic array are brought into proximity with each other as the bag fills.

24. Apparatus as claimed in any one of the preceding claims, wherein as the medical bag fills, the weight of the bag moves the first component in a substantially downward direction on the compression spring located in the second component, causing the magnetic detector or sensor and magnetic array to be brought into proximity with each other.

25. Apparatus as claimed in any one of claims 1 to 22, wherein the magnetic detector or sensor and magnetic array are brought into proximity with each other as the bag empties.

26. Apparatus as claimed in claim 25, wherein as the medical bag empties, the reduction in weight of the medical bag moves the first component in a substantially upward direction on the compression spring located in the second component, causing the magnetic detector or sensor and magnetic array to be brought into proximinity with each other.

27. Apparatus as claimed in any one of the preceding claims, wherein the indicator means is battery operated.

28. Apparatus as claimed in any one of the preceding claims, wherein the indicator means is located on one of the upper or lower components.

29. Apparatus as claimed in any one of claims 1 to 27, wherein the indicator means is located on both of the upper and lower components.

30. Apparatus as claimed in any one of claims 1 to 27, wherein the indicator means is located in a remote location to the apparatus.

31. Apparatus as claimed in any one of the preceding claims, comprising a third tubular component.

32. Apparatus as claimed in claim 31, wherein the indicator means is located on the third tubular component.

33. Apparatus as claimed in claims 31 to 32, wherein the third tubular component has battery access.

34. Apparatus as claimed in any one of the preceding claims which is free standing.

35. Apparatus as claimed in any one of the preceding claims, wherein the lower component has a base.

36. Apparatus as claimed in claim 35, wherein the base has a plurality of feet.
